(19) United States
(12) Patent Application Publication
(10) Pub. No.: US 2026/0252987 A1
(43) Pub. Date: Aug. 27, 2026

(54) TRAVEL PLAN GENERATION SYSTEM

(71) Applicant: NTT DOCOMO, INC., Tokyo (JP)

(72) Inventors: Eri KOIDE, Tokyo (JP); Akira YAMADA, Tokyo (JP); Takashi SUZUKI, Tokyo (JP); Shin ISHIGURO, Tokyo (JP)

(73) Assignee: NTT DOCOMO, INC., Tokyo (JP)

(21) Appl. No.: 19/160,244

(22) PCT Filed: Jan. 4, 2024
(86) PCT No.: PCT/JP2024/000029

§ 371 Date: Aug. 27, 2025

(30) Foreign Application Priority Data
Mar. 22, 2023 (JP) 2023-045360

(51) Int. Cl. G06Q 10/0631; G06Q 10/04; G06Q 30/0241; G06Q 50/40

(52) U.S. Cl. CPC G06Q 10/06315; G06Q 10/04; G06Q 30/0247; G06Q 50/40

(57) ABSTRACT

A travel plan generation system 1 includes a location information acquisition unit 11 configured to acquire location information indicating a location where a taxi starts traveling, a demand information acquisition unit 13 configured to acquire demand information indicating a demand for taxis for each geographical location, an advertisement revenue information acquisition unit 14 configured to acquire advertisement revenue information related to revenue from an advertisement displayed on the taxi's exterior for each geographical location, and a travel plan generation unit 15 configured to generate a travel plan including locations where the taxi will travel on the basis of the location information, the demand information, and the advertisement revenue information.

### TECHNICAL FIELD

The present disclosure relates to a travel plan generation system.

### BACKGROUND ART

Conventionally, there is a system described in Patent Literature 1 as a system for generating a travel plan recommended for a taxi. This system sets a recommended travel plan recommended as a travel plan from a current location of a taxi for a predetermined time so that a passenger pickup possibility within the predetermined time, which is predicted on the basis of a passenger pickup record, is increased.

### CITATION LIST

### Patent Literature

[Patent Literature 1] Japanese Unexamined Patent Publication No. 2020-77433

### SUMMARY OF INVENTION

### Technical Problem

There is a known method for obtaining advertisement revenue by operating a taxi to travel in a state in which an advertisement is displayed on the taxi's exterior. From the viewpoint of increasing the revenue obtained by operating the taxi to travel, it is necessary to generate a travel plan of the taxi in consideration of the advertisement revenue obtained by operating the taxi to travel with a displayed advertisement. However, because the above-described travel plan generation system recommends a travel plan on the basis of only a passenger pickup possibility, there is room for improvement in the revenue obtained by operating a taxi to travel.

The present disclosure has been made in consideration of the above circumstances and an objective of the present disclosure is to provide a travel plan generation system capable of improving revenue obtained by operating a taxi to travel.

### Solution to Problem

According to the present disclosure for achieving the above-described objective, there is provided a travel plan generation system including: a location information acquisition unit configured to acquire location information indicating a location where a taxi starts traveling; a demand information acquisition unit configured to acquire demand information indicating a demand for taxis for each geographical location; an advertisement revenue information acquisition unit configured to acquire advertisement revenue information related to revenue from an advertisement displayed on the taxi's exterior for each geographical location; and a travel plan generation unit configured to generate a travel plan including locations where the taxi will travel on the basis of the location information, the demand information, and the advertisement revenue information.

In the travel plan generation system according to the present disclosure, the travel plan including the location where the taxi will travel is generated on the basis of the location information, the demand information, and the advertisement revenue information. For example, an expectation value of the advertisement revenue obtained by displaying the advertisement on the taxi's exterior and operating the taxi to travel can be acquired as the advertisement revenue information. Because the travel plan is generated in consideration of the expectation value of the advertisement revenue included in the advertisement revenue information in addition to the demand information, for example, the revenue obtained by operating the taxi to travel can be improved compared to when the travel plan is generated in consideration of only the demand for taxis.

### Advantageous Effects of Invention

According to the present disclosure, it is possible to improve revenue obtained by operating a taxi to travel.

### BRIEF DESCRIPTION OF DRAWINGS

FIG. 1 is a diagram showing a configuration of a travel plan generation system according to an embodiment of the present disclosure.

FIG. 2 is a diagram showing an example of a travel plan displayed by a communication terminal shown in FIG. 1.

FIG. 3 is a table showing an example of a demand table stored in a revenue database shown in FIG. 1.

FIG. 4 is a graph showing an example of a capture effect expectation value.

FIG. 5 is a diagram showing a state for deciding a time step for generating a travel plan.

FIG. 6 is a diagram showing a state for deciding a search range for the travel plan.

FIG. 7 is a diagram showing an example of an operation of the travel plan generation system according to the embodiment of the present disclosure.

FIG. 8 is a diagram showing a specific example of a process in the step of generating a travel plan shown in FIG. 7.

FIG. 9 is a diagram showing a state for generating an improved solution for the travel plan.

FIG. 10 is a diagram showing a configuration of hardware of the travel plan generation system according to the embodiment of the present disclosure.

### DESCRIPTION OF EMBODIMENTS

Hereinafter, embodiments of a travel plan generation system of the present disclosure will be described in detail with reference to the accompanying drawings. In the description of the drawings, the same reference signs are used for the same elements and redundant description thereof will be omitted.

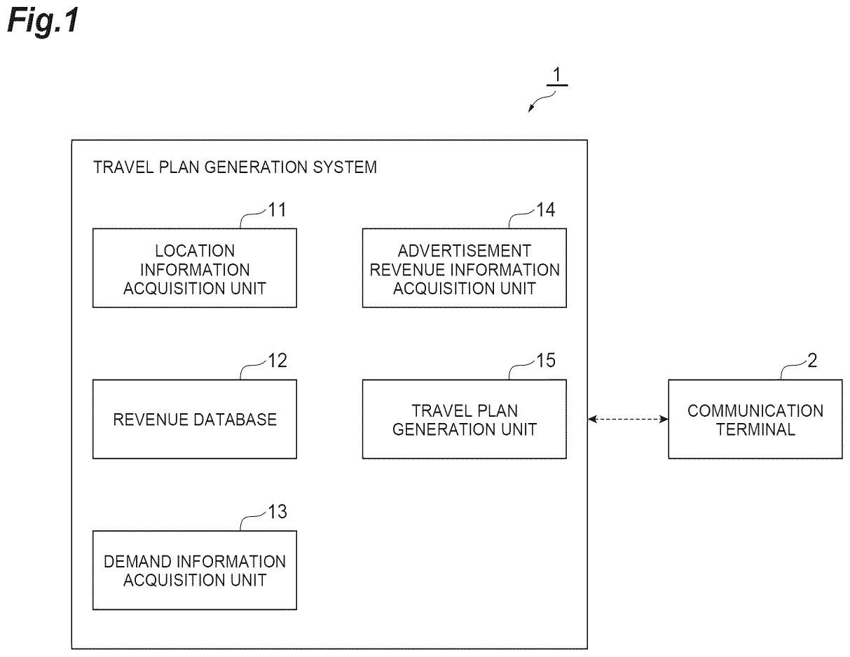

In FIG. 1, a travel plan generation system 1 according to the present embodiment is shown. The travel plan generation system 1 generates a travel plan including locations where a taxi will travel. The travel plan refers to geographical locations where a taxi will travel at each interval of a predetermined time. The travel plan generation system 1, for example, presents the generated travel plan to a user. The user is, for example, a person who operates a taxi to travel in accordance with the travel plan presented by the travel plan generation system 1, such as a taxi driver.

Taxis carry advertisements. The advertisements may be displayed by stickers, rear stickers, and body stickers attached to a taxi body. Moreover, the advertisements may be displayed by body wrapping applied to the taxi body and window signage attached to the windows of the taxi.

When a taxi travels in a state in which an advertisement is displayed on the taxi's exterior, for example, the person operating the taxi to travel can obtain advertisement revenue from advertisers. For example, a taxi company for operating a taxi business can obtain advertisement revenue from advertisers in accordance with the effectiveness of the advertisement estimated on the basis of an area and a time period in which the taxi has traveled. For example, the effectiveness of the advertisement can be improved by operating the taxi to travel on a road with a lot of foot traffic, and as a result, the taxi company can improve its advertisement revenue.

When a taxi does not have a passenger, for example, it travels around the current location to pick up a passenger. At this time, the taxi can efficiently pick up a passenger by traveling in a place such as a business district where there are many people and a high demand for taxis.

The travel plan generation system 1 includes a computer such as a personal computer (PC) or a server device having a communication function. The travel plan generation system 1 may include a plurality of computers, i.e., a computer system. The travel plan generation system 1 can transmit and receive information to and from a communication terminal 2 via a network such as a mobile communication network.

The communication terminal 2 is a terminal to be used by a user. The communication terminal 2 is, for example, an in-vehicle terminal installed in the taxi. The communication terminal 2 may be, for example, a smartphone or a tablet terminal carried by the user. For example, information instructing the generation of a travel plan is input to the communication terminal 2 by the user. The communication terminal 2 transmits the information input by the user to the travel plan generation system 1.

As an example, at a timing when the taxi becomes available, the user inputs the information instructing the generation of a travel plan by operating the communication terminal 2. The travel plan generation system 1 starts generating the travel plan when the information is received from the communication terminal 2, and presents the travel plan up to a certain time later to the user.

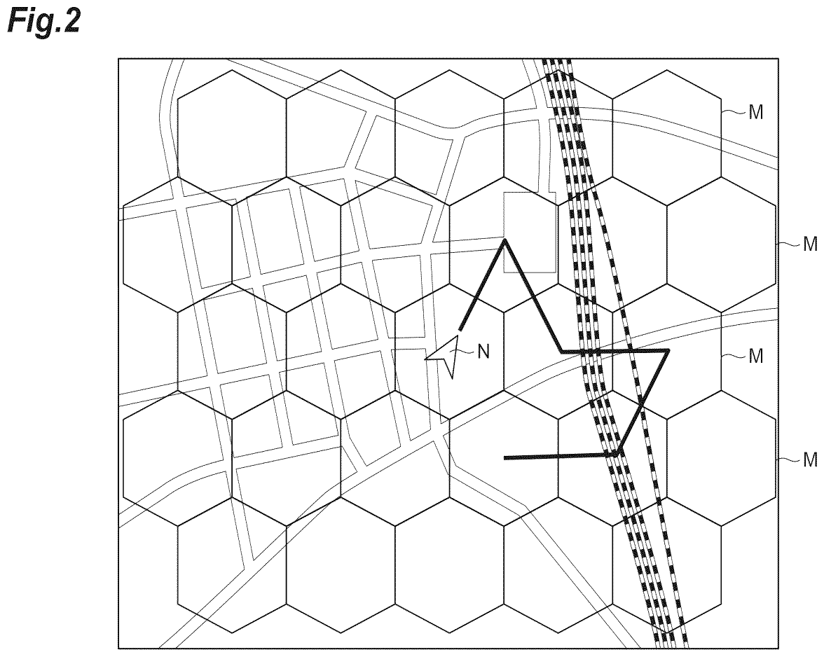

FIG. 2 is a diagram showing an example of a display of a travel plan by the communication terminal 2 shown in FIG. 1. The communication terminal 2 receives a travel plan generated by the travel plan generation system 1 from the travel plan generation system 1. The communication terminal 2 displays the received travel plan. In the present embodiment, the communication terminal 2 acquires and displays a current location N of the taxi. The communication terminal 2, for example, has a positioning function such as a Global Positioning System (GPS) and acquires information indicating the current location N of the taxi by the positioning function.

In order to receive the travel plan from the travel plan generation system 1, the communication terminal 2 transmits, to the travel plan generation system 1, information instructing the generation of a travel plan, including the acquired information indicating the current location N of the taxi. The communication terminal 2 displays a plurality of areas M set in advance as geographical locations. The communication terminal 2 displays, as the travel plan, a sequential order of movement between the plurality of areas M, starting from the area M including the current location N of the taxi, up to a certain time later. A method for setting the plurality of areas M will be described below.

In the present embodiment, the plurality of areas M are set in advance. However, the setting of the plurality of areas M may be executed by the travel plan generation system 1 or may be executed outside the travel plan generation system 1. The areas M are areas obtained by dividing the area where the taxi travels without gaps. The respective areas M have the same shape and size as each other. The shape of the area M is, for example, a hexagon. In this case, because a distance from the center of each area M to another area M adjacent to the area M is constant, it is easy to express the movement of the taxi. The shape of the area M is, for example, set in advance and can be changed as appropriate. A connection relationship between the adjacent areas M on the road is stored in a database as a directed graph representation. The database, for example, may be stored in advance in the travel plan generation system 1 or may be stored in advance outside the travel plan generation system 1.

There is a trade-off relationship between on the one hand the spatial resolution determined by the size and number of areas M and the connection rate of adjacent areas M, and on the other hand the amount of calculation. If the size of the area M decreases and the number of areas M increases, the spatial resolution is raised and the connection rate of adjacent areas M is set in detail, but the amount of calculation increases. On the other hand, if the size of the area M is increased and the number of areas M is decreased, the spatial resolution is lowered and a degree of detail of the connection rate of adjacent areas M is lowered, but the amount of calculation decreases. For example, the plurality of areas M are set so that their size and number are appropriate in accordance with a balance between on the one hand the spatial resolution and the connection rate of the areas M, and on the other hand the amount of calculation.

For example, when a taxi travels in a city, there are many roads, and even if the size of the area M is small, because the connection rate between adjacent areas M on roads is high, the size of the area M can be set to a small size. When a taxi travels in a rural area, there are few roads, and if the size of the area M is set to a small size, an area M that has no connection relationship with adjacent areas M on roads at all or an area M with an extremely small revenue expectation value (to be described below) is easily formed. For this reason, the size of the area M can be set to a large size.

Next, functions of the travel plan generation system 1 according to the present embodiment will be described. As shown in FIG. 1, the travel plan generation system 1 includes a location information acquisition unit 11, a revenue database 12, a demand information acquisition unit 13, an advertisement revenue information acquisition unit 14, and a travel plan generation unit 15.

The location information acquisition unit 11 acquires location information indicating a location where the taxi starts traveling. In the present embodiment, the location information acquisition unit 11 acquires the current location N of the taxi as the location information. The location information acquisition unit 11 receives information instructing the generation of a travel plan from the communication terminal 2 and acquires the location information.

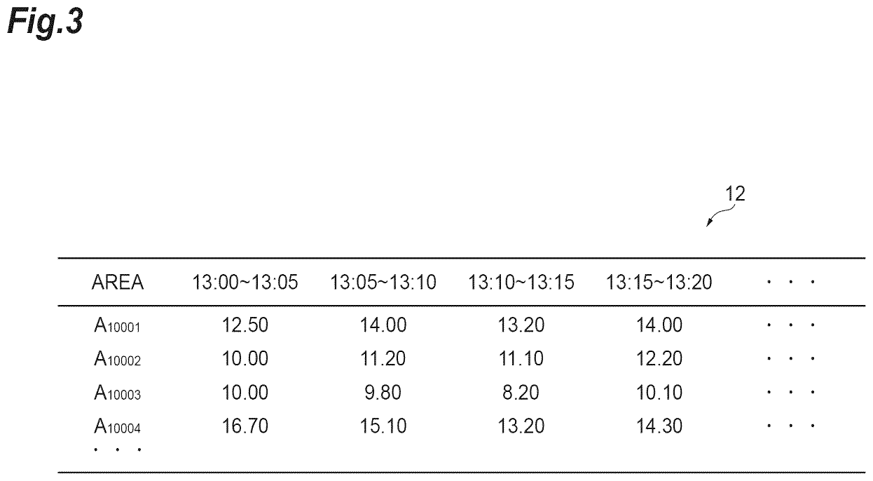

FIG. 3 is a table showing an example of a demand table stored in the revenue database 12 shown in FIG. 1. The revenue database 12 stores a demand table and an advertisement table (not shown). The revenue database 12 may be updated, for example, at an interval of a predetermined time. The predetermined time, for example, is set in advance, and is set to five minutes as an example. The predetermined time can be changed as appropriate.

The demand table describes a passenger expectation value, which is an expectation value of revenue obtained by picking up a passenger for each ID of the area M. Specifically, the passenger expectation value is an expectation value of revenue obtained by picking up a passenger in the corresponding area M when an available taxi is traveling in the area M. The ID of the area M is information for uniquely identifying the area M. The ID of the area M, for example, is set in advance. The demand table, for example, describes a passenger expectation value per minute. The demand table describes a passenger expectation value for each time period having a predetermined time width. The time width, for example, is set in advance and can be changed as appropriate. In the present embodiment, the time width is 5 minutes.

As an example, F_{Aj,τ}, which denotes the passenger expectation value when a taxi travels in an available state in an area Aⱼ in a time period from a predetermined time τ to time τ′ later than τ, is expressed by the following Eq. (1). In Eq. (1), Aⱼ denotes the area M that a taxi travels through as the j^{th} area in the travel plan. N_{Aj,τ} denotes an expectation value of the number of passengers to be picked up in the area Aⱼ in the time period. M_{Aj,τ} denotes the predicted number of taxis passing through the area Aⱼ in the time period. a_{Aj,τ} denotes an average fare when a passenger boards from the area Aⱼ in the time period.

### [Math. 1]

$${F}_{{A}_{j} , τ} = ( \frac{{N}_{{A}_{j} , τ}}{{M}_{{A}_{j} , τ}} \times {a}_{{A}_{j} , τ} ) / ( {τ}^{′} - τ ) \qquad ( 1 )$$

The travel plan generation system 1, for example, may calculate the above N_{Aj,τ}, M_{Aj,τ}, and a_{Aj,τ} on the basis of data of a taxi management system stored in advance in a taxi company server. The data includes, for example, the location of the taxi, the location where the taxi picked up the passenger, and the fare.

The travel plan generation system 1, for example, acquires the number of passengers that the taxi picked up in the past in the area M during the time period on the basis of the above-described data. The travel plan generation system 1, for example, may calculate an average value of the number of passengers on the basis of the number of passengers that the taxi picked up in the past as the above N_{Aj,τ}. The travel plan generation system 1, for example, acquires the fare that the taxi acquired in the past in the area M during the time period on the basis of the above-described data. The travel plan generation system 1, for example, may calculate an average value of the fare that the taxi acquired in the past as the above a_{Aj,τ} on the basis of the fare that the taxi acquired in the past.

The travel plan generation system 1, for example, acquires information indicating locations where the taxis traveled in the past on the basis of the above-described data. The travel plan generation system 1, for example, calculates an expectation value of a distribution of taxis for each area M on the basis of the information indicating the locations. For taxis that do not use the travel plan generation system 1 according to the present embodiment, the travel plan generation system 1, for example, calculates the number of taxis passing through the area M in the time period on the basis of the expectation value of the area M of the distribution of the taxis. For taxis that use the travel plan generation system 1 according to the present embodiment, the travel plan generation system 1, for example, calculates the number of taxis passing through the area M in the time period on the basis of the taxi travel plan generated by the travel plan generation system 1. The travel plan generation system 1, for example, may calculate an average value of the number of taxis as the above M_{Aj,τ} on the basis of the number of taxis passing through the area M in the time period. The method for calculating the above N_{Aj,τ}, M_{Aj,τ}, and a_{Aj,τ} is not limited to the above-described one, and other methods may be used. Moreover, F_{Aj,τ} itself may be set by a method other than the above.

The advertisement table describes an advertisement expectation value, which is the expectation value of revenue obtained from viewing an advertisement, for each ID of the area M. Specifically, the advertisement expectation value is the expectation value of advertisement revenue that a taxi company can obtain when a viewer located in an area M views an advertisement placed in a taxi while the available taxi is traveling through the corresponding area M. The advertisement table describes, for example, an advertisement expectation value per minute. The advertisement table, for example, describes an advertisement expectation value for each time period having a predetermined time width. The time width is similar to that of the demand table.

As an example, P_{Aj,τ}, which is the advertisement expectation value in the time period from τ to τ′, is expressed by the following Eq. (2). In Eq. (2), O_{Aj,τ} denotes an expectation value of the number of exposed viewers in the area M in the time period, a_{Aj,τ} denotes a capture effect expectation value, and b denotes a fixed value of advertisement revenue.

### [Math. 2]

$${P}_{{A}_{j} , τ} = ( {O}_{{A}_{j} , τ} = \times {α}_{{A}_{j} , τ} \times b ) / ( {τ}^{′} - τ ) \qquad ( 2 )$$

The travel plan generation system 1, for example, acquires a predictive value of the number of pedestrians (population) in the area M during the time period from the population of the area where the area M is set. The population of the area, for example, is stored in advance in a database. The travel plan generation system 1 sets the predictive value of the number of pedestrians as the above O_{Aj,τ}. The above b, for example, is set in advance.

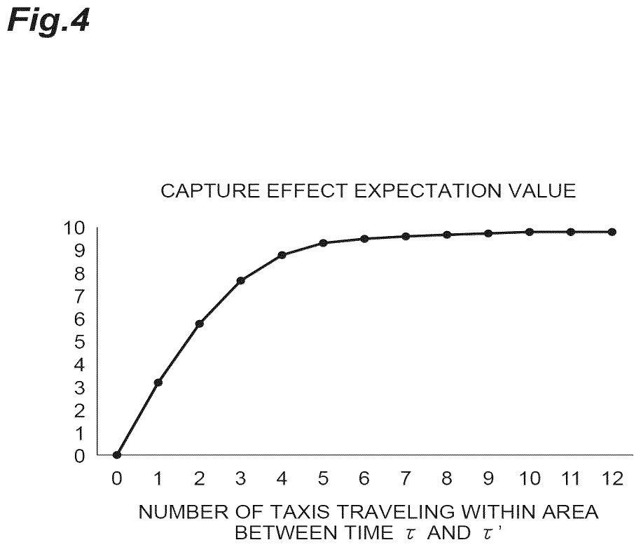

FIG. 4 is a graph showing an example of the capture effect expectation value. The capture effect expectation value is an expectation value of effect per viewer obtained by viewing the same advertisement in the same time period. As the number of taxis that carry advertisements with similar content and that travel through the area M in the time period increases, a possibility and frequency that advertisements with similar content will be seen by viewers increase and the capture effect expectation value increases. Moreover, as the number of taxis that travel through the area M in the time period increases, the slope of the capture effect expectation value decreases. As shown in FIG. 4, the capture effect expectation value is expressed by a logarithmic function.

The travel plan generation system 1 stores, in advance, a graph of the capture effect expectation value shown in FIG. 4. The travel plan generation system 1, for example, calculates the value corresponding to the calculated M_{Aj,τ} in the graph as the above α_{Aj,τ} on the basis of the calculated M_{Aj,τ} and the graph stored in advance. The method for calculating the above O_{Aj,τ} and a_{Aj,τ} is not limited to the above, and other methods may be used. Moreover, P_{Aj,τ} itself may be set by a method other than the above.

The demand information acquisition unit 13 shown in FIG. 1 acquires demand information indicating the demand for taxis for each geographical location. The demand information includes the above-described passenger expectation value. In the present embodiment, the demand information acquisition unit 13 acquires the passenger expectation value for each of the plurality of areas M as demand information with reference to the demand table stored in the revenue database 12.

The advertisement revenue information acquisition unit 14 acquires advertisement revenue information related to the revenue of an advertisement displayed on the taxi's exterior for each geographical location. The advertisement revenue information includes the above-described advertisement expectation value. In the present embodiment, the advertisement revenue information acquisition unit 14 acquires the advertisement expectation value for each of the plurality of areas M as the advertisement revenue information with reference to the advertisement table stored in the revenue database 12.

The travel plan generation unit 15 generates a travel plan including locations where the taxi will travel on the basis of the location information acquired by the location information acquisition unit 11, the demand information acquired by the demand information acquisition unit 13, and the advertisement revenue information acquired by the advertisement revenue information acquisition unit 14. In the present embodiment, the travel plan is generated by optimizing the locations where the taxi will travel on the basis of the demand for taxis and the revenue from the advertisement.

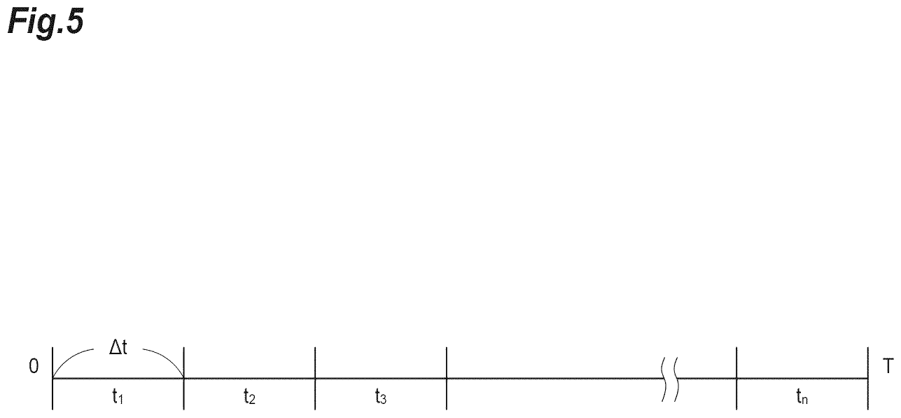

FIG. 5 is a diagram showing a state for deciding a time step for generating a travel plan. The travel plan generation unit 15 decides a plan segment T, which is a time length for creating a travel plan. The plan segment refers to a period from a timing at which the taxi starts traveling according to the travel plan to a timing at which the taxi ends traveling. The travel plan generation unit 15 stores a plan segment T set in advance. The travel plan generation unit 15, for example, acquires a past average time from the time when the taxi becomes available to the time when the next passenger is found in the area and the time period in which the taxi travels. The past average time is, for example, stored in advance. The travel plan generation unit 15 decides a plan segment on the basis of the past average time. As an example, the travel plan generation unit 15 may decide the past average time as the plan segment. For example, when a taxi travels in a city, T is set to a short segment because the population is large and the expectation value of the number of passengers to be picked up is large. In contrast, when a taxi travels in a rural area (e.g., suburbs), T is set to a long segment because the population is small and the expectation value of the number of passengers to be picked up is small.

The travel plan generation unit 15 decides a time step by dividing the plan segment into n equal parts (n is any natural number). The time step refers to one time period when the plan segment is divided into n equal parts. The above n is set in advance so that the time width of each time step is greater than or equal to a predetermined time. The predetermined time is, for example, a period sufficient for a taxi to travel from one end to the other end of the area M in one direction.

The travel plan generation unit 15 decides an area M in which the taxi will travel for each time step as a travel plan. The travel plan generation unit 15 may generate a travel plan under the assumption that the taxi travels through the same area M across a plurality of time steps. Hereinafter, for ease of description, the n^{th} time step from a timing at which the taxi starts traveling according to the travel plan is defined as tₙ.

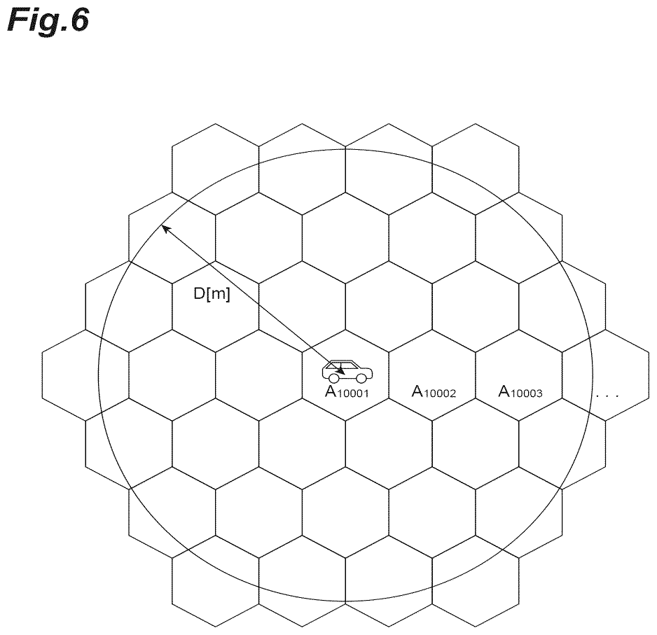

FIG. 6 is a diagram showing a state for deciding a search range, which is a geographical range serving as a travel plan target. The travel plan generation unit 15 acquires an average travel speed of the taxi in the area where the taxi travels. The average travel speed, for example, is calculated from the past speed of the taxi. The travel plan generation unit 15 decides the search range of the travel plan on the basis of the average travel speed and the plan segment. The travel plan generation unit 15 decides an area M included within a radius D from the current location N of the taxi as the search range of the travel plan. If the above average travel speed is denoted by v, for example, the following Eq. (3) may be satisfied.

### [Math. 3]

$$D = v \cdot T \qquad ( 3 )$$

The travel plan generation unit 15 calculates the revenue expectation value for each area M on the basis of the demand information acquired by the demand information acquisition unit 13 and the advertisement revenue information acquired by the advertisement revenue information acquisition unit 14. In the present embodiment, the travel plan generation unit 15 acquires the passenger expectation value as demand information with reference to the demand table stored in the revenue database 12. The travel plan generation unit 15 acquires the advertisement expectation value as advertisement revenue information with reference to the advertisement table stored in the revenue database 12. The revenue expectation value is the expectation value of revenue to be obtained when the taxi travels through the area M, and is calculated in consideration of both the passenger expectation value and the advertisement expectation value.

As an example, FP_{Xi}, which is the revenue expectation value in area M in a time step tᵢ, is expressed by the following Eq. (4). In Eq. (4), Xᵢ denotes an area M where the taxi travels in the time step tᵢ. τ_{Xi} denotes a timing at which the taxi travels through Xᵢ. w_{F,Xi} denotes a weighting coefficient related to the revenue obtained by picking up a passenger and w_{P,Xi} denotes a weighting coefficient related to the revenue obtained by viewing an advertisement. F_{Xi} denotes a passenger expectation value obtained at τ_{Xi} in Xᵢ and P_{Xi} denotes an advertisement expectation value obtained at τ_{Xi} in Xᵢ. w_{F,Xi} and w_{P,Xi}, for example, are set in advance. At denotes a time width in each time step.

### [Math. 4]

$${FP}_{{x}_{i}} = {w}_{F , {x}_{i}} \cdot {F}_{{x}_{i}} \cdot Δ t + {w}_{P , {x}_{i}} \cdot {P}_{{x}_{i}} \cdot Δ t \qquad ( 4 )$$

The travel plan generation unit 15 generates a sequential order of movement between a plurality of areas M that are set in advance as a travel plan. As an example, the travel plan generation unit 15 generates x, which is a solution related to the sequential order of movement between the plurality of areas M, as the travel plan. For example, an example of x is expressed by the following Eq. (5). In Eq. (5), A₁₀₀₀₀₁, A₁₀₀₀₀₃, and the like are IDs of areas M. x includes a permutation of the areas M where the taxi travels in the plan segment.

### [Math. 5]

$$x = ( {A}_{100001} , {A}_{100003} , {A}_{100008} ⋯ {A}_{100010} ) \qquad ( 5 )$$

The travel plan generation unit 15 calculates the total revenue on the basis of the revenue expectation value acquired for each area M in the time step tᵢ included in the generated solution x. For example, the travel plan generation unit 15 calculates the total revenue as the sum of the revenue expectation values for each area M in the time step tᵢ included in x. As an example, the total revenue f(x) is expressed by the following Eq. (6).

### [Math. 6]

$$f ( x ) = {\sum }_{{x}_{i} ∈ x} ( {w}_{F , {x}_{i}} \cdot {F}_{{x}_{i}} \cdot Δ t + {w}_{P , {x}_{i}} \cdot {P}_{{x}_{i}} \cdot Δ t ) \qquad ( 6 )$$

The travel plan generation unit 15 outputs the generated travel plan. As the output, for example, the travel plan generation unit 15 displays the travel plan on the communication terminal 2 (see FIG. 2). A method by which the travel plan generation unit 15 generates the travel plan will be described below.

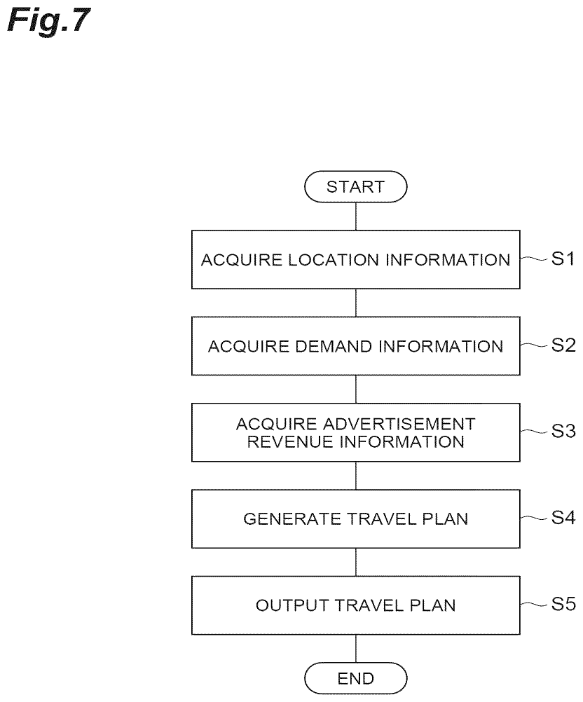

Next, an example of an operation of the travel plan generation system 1 according to the present embodiment will be described with reference to FIGS. 7 to 9. FIG. 7 is a flowchart showing an example of the operation of the travel plan generation system 1 according to the present embodiment. In the present process, the travel plan generation system 1 receives information instructing the generation of a travel plan from the communication terminal 2.

Subsequently, location information is acquired by the location information acquisition unit 11 (step S1). In step S1, when the location information acquisition unit 11 receives the information instructing the generation of a travel plan from the communication terminal 2, the location information acquisition unit 11 acquires a current location N of the taxi as the location information.

Subsequently, the demand information acquisition unit 13 acquires demand information (step S2). In step S2, the demand information acquisition unit 13 acquires the demand information for each geographical location and time period. In the present embodiment, the demand information acquisition unit 13 acquires passenger expectation values for each of a plurality of areas M and each time period as the demand information with reference to the demand table stored in the revenue database 12.

Subsequently, the advertisement revenue information acquisition unit 14 acquires advertisement revenue information (step S3). In step S3, the advertisement revenue information acquisition unit 14 acquires the advertisement revenue information for each geographical location and time period. In the present embodiment, the advertisement revenue information acquisition unit 14 acquires advertisement expectation values for each of a plurality of areas M and each time period as the advertisement revenue information with reference to the advertisement table stored in the revenue database 12.

Subsequently, the travel plan generation unit 15 generates a travel plan (step S4). In step S4, the travel plan generation unit 15 generates a travel plan including locations where the taxi will travel on the basis of the location information acquired by the location information acquisition unit 11, the demand information acquired by the demand information acquisition unit 13, and the advertisement revenue information acquired by the advertisement revenue information acquisition unit 14.

In step S4, the travel plan generation unit 15 first decides T, which is a plan segment of the travel plan. Subsequently, the travel plan generation unit 15 decides a search range of the travel plan (an area M included in the search range) on the basis of the average travel speed of the taxi and the plan segment. Subsequently, the travel plan generation unit 15 decides a time step by dividing the plan segment into n equal parts. Also, the travel plan generation unit 15 acquires revenue expectation values for each of the areas M and each time period by substituting the passenger expectation value and the advertisement expectation value into the above Eq. (4) on the basis of the passenger expectation value included in the demand information acquired in step S2 and the advertisement expectation value included in the advertisement revenue information acquired in step S3.

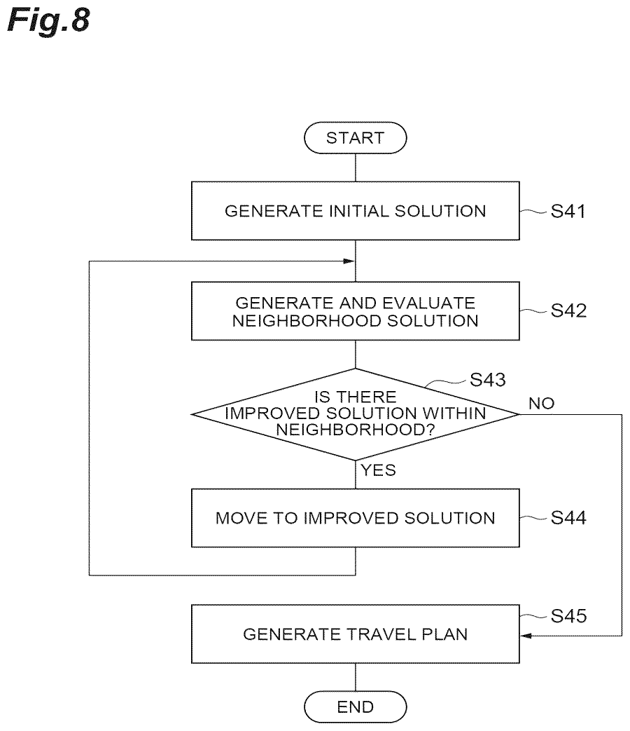

Subsequently, the travel plan generation unit 15 generates a travel plan by executing the process shown in FIG. 8. The travel plan generation unit 15 decides the sequential order of the areas M in which the taxi travels for each time step as the travel plan. The travel plan generation unit 15 generates x, which is a solution related to the sequential order of movement between a plurality of areas M, as the travel plan.

FIG. 8 is a diagram showing a specific example of a process in the step of generating the travel plan shown in FIG. 7. In the present process, the travel plan generation unit 15 generates an initial solution of the travel plan on the basis of the acquired revenue expectation value for each area M (step S41). In the initial solution, the travel plan generation unit 15 sets the area M including the current location N of the taxi to X₁. Moreover, the travel plan generation unit 15 sets the area M having the maximum revenue expectation value among the areas M adjacent to X₁ to X₂. Likewise, the travel plan generation unit 15 sets the area M having the maximum revenue expectation value among the areas M adjacent to Xᵢ to Xᵢ₊₁ (i is a natural number less than or equal to n). Moreover, the travel plan generation unit 15 calculates f(x) that is the total revenue by summing up the revenue expectation values for each area M for the generated initial solution on the basis of the acquired revenue expectation value for each area M (see Eqs. (4) and (6)).

Subsequently, the travel plan generation unit 15 generates and evaluates N(x), which is a neighborhood solution of the generated solution x (step S42). N(x) denotes one or more neighborhood solutions of x. In a process for generating the neighborhood solution, a deformation operation performed by the travel plan generation unit 15 is to move Xᵢ while i changes between 2 and n. The area M to which Xᵢ can move is an area M that has a connection relationship on roads with both Xᵢ₋₁ and Xᵢ₊₁. If there is a connection relationship on roads between Xᵢ and Xᵢ₋₁ and between Xᵢ and Xᵢ₊₁, the travel plan generation unit 15 may move Xᵢ to the area M identical to Xᵢ₋₁ or Xᵢ₊₁. In addition, X₁ denotes the current location N of the taxi and no deformation operation is performed in a process for generating the neighborhood solution.

The travel plan generation unit 15 calculates f(x) that is the total revenue by summing up the revenue expectation values for each area M for each N(x) on the basis of the acquired revenue expectation value for each area M (see Eqs. (4) and (6)).

Subsequently, the travel plan generation unit 15 determines whether or not there is an improved solution in the neighborhood (step S43). In step S43, the travel plan generation unit 15 determines whether or not there is x′ where f(x′) is greater than f(x) for x′, which is one solution of N(x), on the basis of the calculated total revenue for x and the calculated total revenue for the neighborhood solutions. When there are a plurality of neighborhood solutions for the generated solution x, the travel plan generation unit 15 determines whether or not there is an improved solution for each of the plurality of neighborhood solutions in step S43.

When there is x′ such that f(x′) is greater than f(x), the travel plan generation unit 15 determines that there is an improved solution in the neighborhood (step S43: YES), identifies x′ as the improved solution, and executes step S44. When there are a plurality of improved solutions x′, the travel plan generation unit 15 executes the process from step S44 with respect to each of the plurality of improved solutions x′. When there is no x′ such that f(x′) is greater than f(x), the travel plan generation unit 15 determines that there is no improved solution in the vicinity (step S43: NO), and executes step S45.

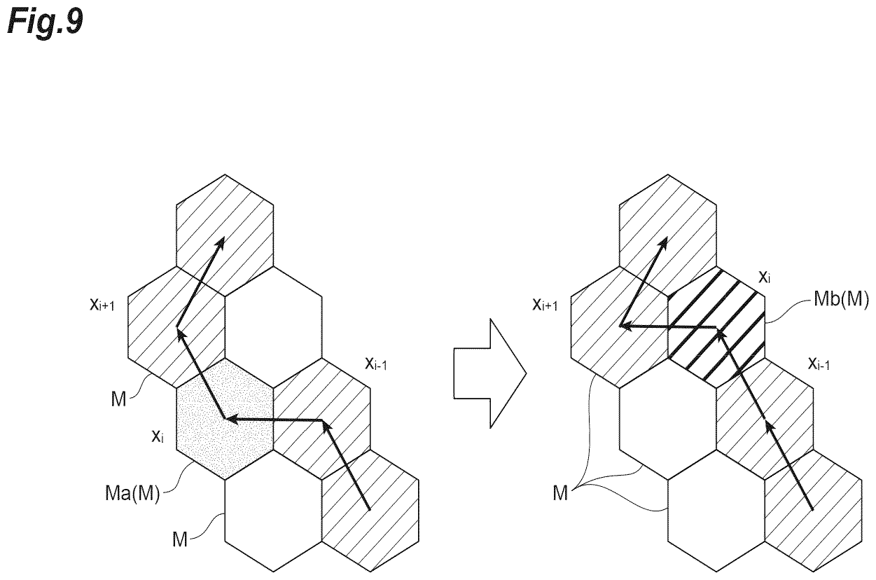

FIG. 9 is a diagram showing a state for generating an improved solution for a travel plan. As shown in FIG. 9, in step S44, the travel plan generation unit 15 moves the solution from the generated solution x to the improved solution x′. In FIG. 9, an example in which Xᵢ is moved from an area Ma to another area Mb is shown. In step S45, the travel plan generation unit 15 calculates x for which there is no improved solution in the neighborhood as a local optimum solution and generates the calculated local optimum solution as a travel plan. In step S45, when there are a plurality of solutions x for which there is no improved solution in the neighborhood, the solution x with the maximum total revenue among the plurality of solutions x is calculated as the local optimum solution. The above is the process executed by the travel plan generation unit 15 in step S4.

In steps S42 to S44, the travel plan generation unit 15 optimizes the travel plan, for example, according to a breadth-first search (BFS). As described above, because the travel plan generation unit 15 searches for a travel plan on the basis of the connection relationship between the roads of adjacent areas M, the same area M may be searched for multiple times. In the breadth-first search, various algorithms for reducing the amount of calculation can be used. For example, the travel plan generation unit 15 may not further search for a solution with lower total revenue (e.g., a solution whose total revenue falls below that of an N^{th} lowest-ranking solution where N is a predetermined number) among a plurality of solutions in each layer of the search. The travel plan generation unit 15 may exclude an area M whose revenue expectation value is less than a predetermined value during the search from the search range. The travel plan generation unit 15 may optimize the travel plan, for example, using a depth-first search or other search methods.

Subsequently, as shown in FIG. 7, the travel plan generation unit 15 outputs a travel plan on the basis of the travel plan generated by the travel plan generation unit 15 (step S5). In step S5, the travel plan generation unit 15 displays the generated travel plan on the communication terminal 2. The above is the process executed by the travel plan generation system 1 according to the present embodiment.

In the present embodiment, a travel plan including the locations where the taxi will travel is generated on the basis of location information, demand information, and advertisement revenue information. For example, an expectation value of advertisement revenue obtained by displaying an advertisement on the taxi's exterior and operating the taxi to travel can be acquired as advertisement revenue information. Because a travel plan is generated in consideration of the expectation value of advertisement revenue included in the advertisement revenue information in addition to the demand information, the revenue obtained by operating the taxi to travel, for example, can be improved compared to when a travel plan is generated in consideration of only the demand for taxis.

As in the present embodiment, the travel plan generation unit 15 may generate a travel plan by optimizing the locations where the taxis travel on the basis of the demand for taxis and the advertisement revenue. In this case, the revenue obtained by operating the taxi to travel can be further improved on the basis of the demand for taxis and the advertisement revenue.

As in the present embodiment, the travel plan generation unit 15 may generate the sequential order of movement between a plurality of areas M that are set in advance as geographical locations as a travel plan. For example, if roads on which a taxi travels are generated as the travel plan, it becomes necessary to calculate the revenue expectation value for each road, which makes the calculation difficult and the data complicated. In this regard, by generating the sequential order of movement between the plurality of areas M as the travel plan, the calculation can be made easier and the data can be simplified.

As in the present embodiment, the demand information may include a passenger expectation value, which is an expectation value of revenue obtained by picking up passengers, and the advertisement revenue information may include an advertisement expectation value, which is an expectation value of revenue obtained by viewing advertisements. In this case, because a travel plan can be generated on the basis of the passenger expectation value and the advertisement expectation value, the revenue obtained by operating a taxi to travel can be further improved.

The configuration and process of the travel plan generation system 1 described in the above-described embodiment are merely examples, and various modifications can be made. Representative modified examples will be described below.

In the above-described embodiment, the travel plan generation unit 15 generates the sequential order of movement between the plurality of areas M as a travel plan. However, the travel plan generation unit 15 may generate a route along roads on which the taxi travels as the travel plan.

A plurality of areas M may be set so that the number of areas M having a revenue expectation value greater than θ is greater than r % for the number of areas M in the above-described search range. In this case, θ and r, for example, may be set in advance and may be changeable as appropriate.

In the above-described embodiment, an example in which the effectiveness of an advertisement changes with the area M and the time period in which the taxi travels and the taxi company obtains advertisement revenue from the advertiser according to the effectiveness of the advertisement has been described. However, the advertisement revenue that the taxi company obtains from the advertiser may be constant regardless of the area M in which the taxi travels. Even in this case, because the travel plan generation system 1 according to the present embodiment generates a travel plan on the basis of both the demand information and the advertisement revenue information, it is possible to improve the revenue that the taxi company obtains by picking up passengers and the revenue of the advertiser obtained by improving the effectiveness of the advertisement.

The content of the revenue database 12 described above are merely examples and are not limited to those described above. The revenue database 12 may be stored outside the travel plan generation system 1. The passenger expectation value and the advertisement expectation value stored in the revenue database 12 may be calculated outside the travel plan generation system 1. In this case, the travel plan generation system 1 may acquire the calculated passenger expectation value and the calculated advertisement expectation value from outside the travel plan generation system 1.

In addition, the block diagrams used to describe the above embodiments show blocks in functional units. These functional blocks (components) are implemented by any combination of at least one of hardware and software. Moreover, a method for implementing each functional block is not particularly limited. That is, each functional block may be implemented using one device physically or logically coupled or may be implemented by directly or indirectly connecting two or more physically or logically separated devices (e.g., using a wired type, a wireless type, or the like) and using these devices. A functional block may be implemented by combining software in the one or more devices described above.

Although functions include judging, deciding, determining, calculating, producing, processing, deriving, examining, searching, checking, receiving, transmitting, outputting, accessing, resolving, selecting, choosing, establishing, comparing, assuming, expecting, regarding, broadcasting, notifying, communicating, forwarding, configuring, reconfiguring, allocating, mapping, assigning, and the like, the present disclosure is not limited thereto. For example, a functional block (component) that performs transmission is called a transmitting unit or transmitter. In either case, as described above, the implementation method is not particularly limited.

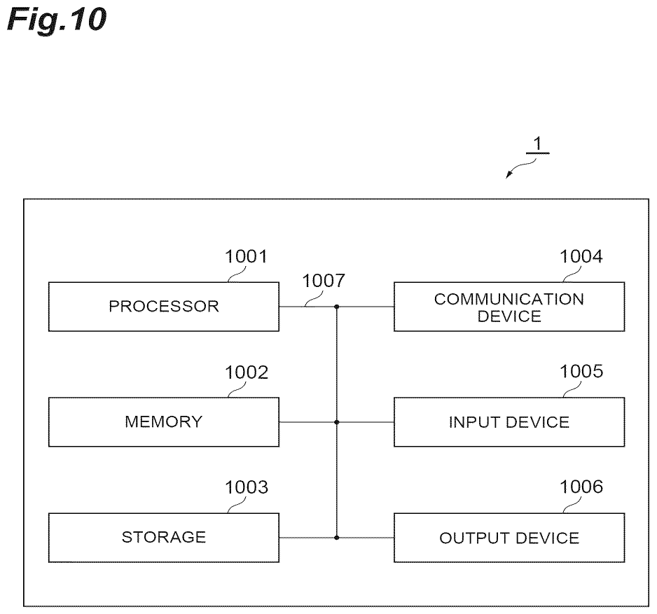

For example, the travel plan generation system 1 or the like in an embodiment of the present disclosure may function as a computer that performs information processing of the present disclosure. FIG. 10 is a diagram showing an example of a hardware configuration of the travel plan generation system 1 according to the embodiment of the present disclosure. The travel plan generation system 1 described above may be physically configured as a computer device including a processor 1001, a memory 1002, a storage 1003, a communication device 1004, an input device 1005, an output device 1006, a bus 1007, and the like. The hardware configuration of the terminal 20 may also be described herein.

Also, in the following description, the term “device” can be read as a circuit, a unit, or the like. The hardware configuration of the travel plan generation system 1 may be configured to include one or more of the devices shown in the drawings, or may be configured without some devices.

Each function in the travel plan generation system 1 is implemented by causing hardware such as the processor 1001 and the memory 1002 to read predetermined software (program), to perform a calculation process of the processor 1001, to control communication by the communication device 1004, or to control at least one of a data reading process and a data writing process in the memory 1002 and the storage 1003.

The processor 1001, for example, operates an operating system to control the entire computer. The processor 1001 may include a central processing unit (CPU) including interfaces with peripheral devices, control devices, calculation devices, registers, and the like. For example, each function in the above-described travel plan generation system 1 may be implemented by the processor 1001.

Moreover, the processor 1001 reads programs (program codes), software modules, and data from at least one of the storage 1003 and the communication device 1004 to the memory 1002 and performs various types of processes in accordance therewith. As the program, a program that causes a computer to execute at least a part of the operation described in the above-described embodiment is used. For example, each function in the travel plan generation system 1 may be implemented by a control program stored in the memory 1002 and operating in the processor 1001. While the various types of processes described above have been described as being executed by one processor 1001, they may be executed simultaneously or sequentially by two or more processors 1001. The processor 1001 may be implemented by one or more chips. In addition, the program may be transmitted from the network via a telecommunications circuit.

The memory 1002 is a computer-readable recording medium, and may include, for example, at least one of a read only memory (ROM), an erasable programmable ROM (EPROM), an electrically erasable programmable ROM (EEPROM), and a random-access memory (RAM). The memory 1002 may also be referred to as a register, a cache, a main memory (a main storage device), or the like. The memory 1002 is capable of storing programs (program codes), software modules, and the like capable of being executed to execute information processing according to an embodiment of the present disclosure.

The storage 1003 is a computer-readable storage medium. The storage 1003 may include, for example, at least one of an optical disc, such as a compact disc ROM (CD-ROM), a hard disk drive, a flexible disk; an optical magnetic disk (e.g., a compact disc, a digital versatile disc, or a Blu-ray (registered trademark) disc), a smart card; a flash memory (e.g., a card, a stick, or a key drive), a floppy (registered trademark) disk, a magnetic strip, or the like. The storage 1003 may be referred to as an auxiliary memory device. The storage medium provided in the travel plan generation system 1 may be, for example, a database including at least one of the memory 1002 and the storage 1003, a server, or another suitable medium.

The communication device 1004 is hardware (a transceiver device) for performing communication between computers via at least one of a wired network and a wireless network. The communication device 1004, for example, is also referred to as a network device, a network control unit, a network card, a communication module, or the like.

The input device 1005 is an input device (e.g., a keyboard, a mouse, a microphone, a switch, a button, a sensor, or the like) that receives an external input. The output device 1006 is an output device (e.g., a display, a speaker, an LED lamp, or the like) that externally provides an output. Also, the input device 1005 and the output device 1006 may have an integrated configuration (e.g., a touch panel).

Moreover, devices such as the processor 1001 and the memory 1002 are connected by the bus 1007 for communicating information. The bus 1007 may be configured using a single bus or may be configured using different buses between the devices.

Moreover, the travel plan generation system 1 may be configured to include hardware such as a microprocessor, a digital signal processor (DSP), an application-specific integrated circuit (ASIC), a programmable logic device (PLD), and a field programmable gate array (FPGA), and some or all functional blocks may be implemented by the hardware. For example, the processor 1001 may be implemented by at least one of the above-described pieces of hardware.

The processing procedure, sequence, flowchart, and the like of the aspects/embodiments described in the present disclosure may be performed in a different order as long as no contradiction is incurred. For example, for a method described in the present disclosure, elements of various devices are described in illustrative order, and the described order is not limited to the specific order.

Input or output information and the like may be stored in a predetermined location (e.g., a memory) or may be managed using a management table. Input or output information and the like can be overwritten or updated, or information may be added thereto. Output information and the like may be deleted. Input information and the like may be transmitted to another device.

Determination may be made by a value represented by one bit (0 or 1), may be made by a Boolean value (Boolean: true or false), or may be made by comparison of numerical values (e.g., comparison with a predetermined value).

Each aspect/embodiment described in the present disclosure may be used alone; may be combined to be used; or may be switched in accordance with execution. Moreover, the notification of predetermined information (e.g., the notification of “being X”) is not limited to the notification that is made explicitly; and the notification may be made implicitly (e.g., the notification of the predetermined information is not performed).

Although the present disclosure has been described in detail above, it is clear to those skilled in the art that the present disclosure is not limited to the embodiments described in the present disclosure. The present disclosure can be practiced with modifications and variations without departing from the spirit and scope of the present disclosure as defined by the claims. Accordingly, the description of the present disclosure is for illustrative purposes and is not meant to be limiting in any way.

Regardless of whether it is referred to as software, firmware, middleware, microcode, hardware description language, or another name, the software should be interpreted broadly so as to imply a command, a command set, a code, a code segment, a program code, a program, a subprogram, a software module, an application, a software application, a software package, a routine, a subroutine, an object, an executable file, an execution thread, a procedure, a function, and the like.

Moreover, software, a command, information, and the like may be transmitted and received through a transmission medium. For example, when the software is transmitted from a website, a server, or another remote source using at least one of wired technology (such as a coaxial cable, an optical fiber cable, a twisted pair, and a digital subscriber line (DSL)) and wireless technology (such as infrared and microwaves), at least one of the wired technology and wireless technology is included within the definition of the transmission medium.

The terms “system” and “network” used in the present disclosure are used interchangeably.

Moreover, the information, parameters, and the like, which are described in the present disclosure, may be represented using absolute values, may be represented using relative values from predetermined values, or may be represented using any other corresponding information.

The terms “determining” and “deciding” used in the present disclosure may include various types of operations. For example, “determining” and “deciding” may include deeming that a result of judging, calculating, computing, processing, deriving, investigating, looking up, search, and inquiry (e.g., search in a table, a database, or another data structure), or ascertaining is determined or decided. Moreover, “determining” and “deciding” may include, for example, deeming that a result of receiving (e.g., reception of information), transmitting (e.g., transmission of information), input, output, or accessing (e.g., accessing data in memory) is determined or decided. Moreover, “determining” and “deciding” may include deeming that a result of resolving, selecting, choosing, establishing, or comparing is determined or decided. In other words, “determining” and “deciding” may include deeming that some operation is determined or decided. Moreover, “determining (deciding)” may be read as “assuming,” “expecting,” “considering,” or the like.

The terms “connected,” “coupled,” and any variation thereof mean any direct or indirect connection or coupling among a plurality of elements and can include the presence of one or more intermediate elements between two elements being “connected” or “coupled.” Couplings or connections between elements may be physical, logical, or a combination thereof. For example, “connection” may be read as “access.” As used in the present disclosure, two elements are defined to be “connected” or “coupled” to each other using at least one of one or more wires, cables, and printed electrical connections and, as some non-limiting and non-exhaustive examples, in the radio frequency domain, electromagnetic energy having wavelengths in the microwave and optical (both visible and invisible) regions, and the like.

The expression “on the basis of” used in the present disclosure does not mean “on the basis of only” unless otherwise stated particularly. In other words, the expression “on the basis of” means both “on the basis of only” and “on the basis of at least.”

Any reference to elements using names, such as “first” and “second,” which are used in the present disclosure, does not generally limit the quantity or order of these elements. These names are used in the present disclosure as a convenient method for distinguishing two or more elements. Accordingly, the reference to the first and second elements does not imply that only the two elements can be adopted, or does not imply that the first element must precede the second element in any way.

As long as “include,” “including,” and the variations thereof are used in the present disclosure, these terms are intended to be comprehensive, like the term “comprising.” Furthermore, it is intended that the term “or” used in the present disclosure is not “exclusive OR.”

In the present disclosure, if articles, such as a, an, and the in English, are added according to translation, the present disclosure may include that the nouns following these articles have plural forms.

In the present disclosure, the term “A and B are different” may mean that “A and B are different from each other.” The term may also mean that “A and B are different from C.” The terms such as “separate,” “coupled,” and the like may also be interpreted like the term “different.”

A travel plan generation system of the present disclosure has the following configuration.

[1] A travel plan generation system including:
a location information acquisition unit configured to acquire location information indicating a location where a taxi starts traveling;
a demand information acquisition unit configured to acquire demand information indicating a demand for taxis for each geographical location;
an advertisement revenue information acquisition unit configured to acquire advertisement revenue information related to revenue from an advertisement displayed on the taxi's exterior for each geographical location; and
a travel plan generation unit configured to generate a travel plan including locations where the taxi will travel on the basis of the location information, the demand information, and the advertisement revenue information.

[2] The travel plan generation system according to [1], wherein the travel plan generation unit generates the travel plan by optimizing the location where the taxi will travel on the basis of the demand for taxis and the revenue of the advertisement.

[3] The travel plan generation system according to [1] or [2], wherein the travel plan generation unit generates a sequential order of movement between a plurality of areas set in advance as the geographical location as the travel plan.

[4] The travel plan generation system according to any one of [1] to [3], wherein the demand information includes a passenger expectation value that is an expectation value of revenue obtained by picking up a passenger, and wherein the advertisement revenue information includes an advertisement expectation value that is an expectation value of the revenue obtained by viewing the advertisement.

### REFERENCE SIGNS LIST

1 Travel plan generation system
11 Location information acquisition unit
13 Demand information acquisition unit
14 Advertisement revenue information acquisition unit
15 Travel plan generation unit
M Area

1. A travel plan generation system comprising:
a location information acquisition unit configured to acquire location information indicating a location where a taxi starts traveling;
a demand information acquisition unit configured to acquire demand information indicating a demand for taxis for each geographical location;
an advertisement revenue information acquisition unit configured to acquire advertisement revenue information related to revenue from an advertisement displayed on the taxi's exterior for each geographical location; and
a travel plan generation unit configured to generate a travel plan including locations where the taxi will travel on the basis of the location information, the demand information, and the advertisement revenue information.

2. The travel plan generation system according to claim 1, wherein the travel plan generation unit generates the travel plan by optimizing the location where the taxi will travel on the basis of the demand for taxis and the revenue of the advertisement.

3. The travel plan generation system according to claim 1, wherein the travel plan generation unit generates a sequential order of movement between a plurality of areas set in advance as the geographical location as the travel plan.

4. The travel plan generation system according to claim 1,
wherein the demand information includes a passenger expectation value that is an expectation value of revenue obtained by picking up a passenger, and
wherein the advertisement revenue information includes an advertisement expectation value that is an expectation value of the revenue obtained by viewing the advertisement.
